(19) United States
(12) Patent Application Publication
(10) Pub. No.: US 2005/0221179 A1
(43) Pub. Date: Oct. 6, 2005

(54) Active mixed nickel hydroxide cathode material for alkaline storage batteries and process for its production

(75) Inventors: Peter Baeuerlein, Lindwedel (DE); Bernd Schultheis, Sondershausen (DE); Wolfgang Reichel, Sondershausen (DE); Heinz Scherzberg, Sondershausen (DE)

Correspondence Address: FOLEY & LARDNER, 777 EAST WISCONSIN AVENUE, SUITE 3800, MILWAUKEE, WI, 53202-5308, US

(73) Assignee: Varta Automotive Systems GmbH

(21) Appl. No.: 11/088,251

(22) Filed: Mar. 23, 2005

Related U.S. Application Data
(63) Continuation of application No. PCT/DE03/03219, filed on Sep. 26, 2004.

(30) Foreign Application Priority Data
Sep. 28, 2002 (DE) 102 45 467.1

(51) Int. Cl. H01M 4/32; C01G 53/04

(52) U.S. Cl. 429/223; 252/182.1; 423/594.19

(57) ABSTRACT

A mixed nickel hydroxide cathode material for use in alkaline storage batteries and having a bimodal particle size distribution includes a main population of particles and a secondary population of particles. The main population has a median mass-based particle size distribution value, derived from laser particle analyses, of between 5 μm and 25 μm. The secondary population has a median mass-based particle size distribution value, derived from laser particle analyses, of between 0.3 μm and 3 μm. The main population is present in the mixed nickel hydroxide cathode material in a proportion of between 70% and 96% by mass.

### CROSS-REFERENCE TO RELATED PATENT APPLICATIONS

This application is a Continuation under 35 U.S.C. §120 of International Application PCT/DE03/03219, filed Sep. 26, 2004, which claims the benefit of Germany Priority Application DE 102 45 467.1, filed Sep. 28, 2002. International Application PCT/DE03/03219 and Germany Priority Application DE 102 45 467.1 are incorporated by reference herein in their entirety, including the specification, drawings, claims, and abstract.

### BACKGROUND

The present invention relates to an active mixed nickel hydroxide cathode material for alkaline storage batteries and to a process for its production. More precisely, the present invention relates to a mixed nickel hydroxide material which comprises a main population and a secondary population of defined amount and size, and to processes in which bimodal mixed nickel hydroxide is obtained in one process step.

Mixed nickel hydroxide electrodes which comprise mainly nickel hydroxide as an active material are used as positive electrodes in nickel-cadmium (NiCd) and nickel-metal-hydride (NiMH) storage batteries. Rising demands for improved capacity of storage batteries, especially with regard to the use of such storage batteries in transportable electrical equipment or in vehicles, has resulted in a requirement for an increased energy density of the storage batteries used. The energy density of the storage batteries depends substantially upon the quality of the mixed nickel hydroxide material used to produce the positive electrodes. A particularly advantageous material has high electrochemical storage capacity and high tamped density.

To improve the properties of mixed nickel hydroxide cathode materials, there are various approaches which relate to the composition and also to the preparation method of the material.

For example, European patent EP 0353837 B1 describes a basic process for producing the mixed nickel hydroxides by combining a nickel(II) salt solution, an ammonium source, and a hydroxide source. The result is a nickel electrode which comprises a nickel hydroxide powder having zinc or magnesium in solid solution in crystals of the nickel hydroxide, the zinc or magnesium being present, respectively, in the range of from 3 to 10% by weight and of from 1 to 3% by weight, and the pore size in the powder not being greater than 3 mm as the radius and the pore volume being less than 0.05 cm³/g. The material is produced by depositing nickel hydroxide crystals which contain a small amount of zinc or magnesium out of an aqueous sulfate solution to which ammonium sulfate has been added, after which sodium hydroxide or potassium hydroxide is added in order to bring the pH between 11 and 13.

Japanese patent application publication JP 3252318 discloses a process for producing spherical nickel hydroxide particles which may comprise cobalt or cadmium. In this process, a reactor is charged continuously with (a) an aqueous nickel salt solution or an aqueous solution which comprises nickel salt, cobalt salt and a cadmium salt, (b) an aqueous solution of an alkali metal hydroxide, and (c) an ammonium ion donor in order to generate nickel hydroxide particles or a cobalt- or cadmium-containing nickel hydroxide particle. The reaction is promoted by keeping the temperature at a level of from 20 to 80° C. and the pH at a certain value in the range from 9 to 12 and the continuous withdrawal of the product. The process is suitable for being able to preferentially prepare quite specific particle sizes by establishing certain conditions. In order to obtain a desired particle size distribution in the cathode material, two mixed oxides which have been produced under different conditions and each have relatively narrow particle size distribution are mixed in a given ratio in a further processing step. As can be seen in particular from the figures, the subsequent mixing does not achieve optimal distribution of the different-sized particles of the mixed hydroxides.

An active nickel hydroxide powder for use in the production of positive nickel electrodes is also illustrated in the European patent EP 0523284 B 1. Before the production of the positive electrode, the powder is a mixture of spherical and virtually spherical particles and nonspherical particles which comprise a nickel hydroxide powder having 1-7% by weight of at least one element selected from the group of cadmium, calcium, zinc, magnesium, iron, cobalt, manganese, cobalt oxide, zinc oxide and cadmium oxide. The powder is obtained from an aqueous solution of a nickel salt and at least one selected element, by controlling the reaction pH to 11.3±0.2 and the reaction temperature to 30-40° C.

European patent EP 0658514 B1 describes a process for continuously producing sparingly soluble metal hydroxides of the general formula M^{(X)}(OH)ₓ where M=Co, Zn, Ni or Cu and x is the valency of the metal. In a first step, a metal hydroxide obtained by anodic oxidation of metal is with a complexing agent L in the presence of alkali metal salts AY to give the metal complex salt of the general formula MLₙYₘ and alkali metal hydroxide solution is decomposed at pH values of greater than 7 to give sparingly soluble metal hydroxides, complexing agents and alkali metal salt, the complexing agent L and the alkali metal salt AY being recycled in a first step and the decomposition of the metal complex salt being undertaken with the alkali metal hydroxide solution formed in the first stage.

Scherzberg et al., Chemie Ingenieur Technik 70 12/1998 p.1530-1535 reports on the preparation of uniformly monomodal hydroxides such as magnesium hydroxides and nickel hydroxides which are characterized by a narrow-band particle size distribution. With the apparatus described there, it is possible to produce particulate metal hydroxides having narrow particle size distribution.

It would be advantageous to provide an electrochemically highly durable mixed nickel hydroxide having relatively high electrochemical storage capacity, relatively low self-discharge, and relatively high BET surface area at sufficiently high tamped density.

### SUMMARY

The present invention relates to a mixed nickel hydroxide cathode material for use in alkaline storage batteries that has a bimodal particle size distribution. The mixed nickel hydroxide cathode material includes a main population of particles and a secondary population of particles. The main population has a median mass-based particle size distribution value, derived from laser particle analyses, of between 5 μm and 25 μm. The secondary population has a median mass-based particle size distribution value, derived from laser particle analyses, of between 0.3 μm and 3 μm. The main population is present in the mixed nickel hydroxide cathode material in a proportion of between 70% and 96% by mass.

The present invention also relates to a process for producing a mixed nickel hydroxide cathode material. The process includes providing a reaction mixture in a loop reactor having an integrated clarifying zone. The reaction mixture includes mixed nickel hydroxide, an aqueous solution of alkali metal ions, nickel(II) ions, ammonia, OH— ions, at least one cation selected from the group consisting of divalent and trivalent cations, and at least one anion selected from the group consisting of monovalent and divalent anions. The process also includes adding to the reaction mixture a nickel(II) salt solution provided with metal ions, an aqueous ammonia solution, and an alkali metal hydroxide solution to form a particulate mixed nickel hydroxide cathode material. The process also includes discharging the particulate mixed nickel hydroxide cathode material from the loop reactor as a solid with the reaction mixture and filtering the particulate mixed nickel hydroxide cathode material from the reaction mixture.

### BRIEF DESCRIPTION OF THE DRAWINGS

FIG. 1 is an apparatus scheme of the process for preparing nickel hydroxide cathode material according to an exemplary embodiment.

FIG. 2 is an illustration of a loop reactor used to prepare the nickel hydroxide material according to an exemplary embodiment.

FIG. 3 is a graphic representation of the UV spectrum of the reaction solution according to an exemplary embodiment.

FIG. 4 is a graphical representation of the distribution of particle sizes after 24 hours for a nickel hydroxide cathode material according to an exemplary embodiment.

FIG. 5 is a graphical representation of the distribution of the particle sizes after 46 hours for a nickel hydroxide cathode material according to an exemplary embodiment.

FIG. 6 is a graphical representation of the distribution of the particle sizes after 78 hours for a nickel hydroxide cathode material according to an exemplary embodiment.

### DETAILED DESCRIPTION OF EXEMPLARY EMBODIMENTS

According to an exemplary embodiment, a mixed nickel hydroxide cathode material may be produced which is intended for use in alkaline storage batteries and includes a bimodal mass-based particle size distribution in which the median of the mass-based particle size distribution of the main population is between 5 μm and 25 μm, the median value of the mass-based particle size distribution of the secondary population is between 0.3 μm and 3 μm, and the fraction by mass of the main population is from 70 to 96%.

It has been found that such a mixed nickel hydroxide cathode material, even in the event of a high degree of crystal defects (the half-height width of the 101 and 102 reflections in x-ray diffractometry serves as a measure here), shows a sufficiently high tamped density.

Too high a degree of order in the crystal leads to nonoptimal electrochemical properties, such as a reduced storage capacity. However, an increase in the defects in the crystal has to date led to a worsening in the mechanical properties, such as a fall in the tamped density below 1.5 g/m³, poorer filterability, and a wider range of the particle size distribution. By providing a mixed nickel hydroxide cathode material, which is characterized in that it comprises two defined populations, a main population and a secondary population, it is possible to overcome the above disadvantages.

According to an exemplary embodiment, such a mixed nickel hydroxide cathode material may be obtained by generating a precipitation product which consists of a main population and a secondary population with regard to the mass-based distribution over the particle size and is also referred to herein as bimodally distributed mixed nickel hydroxide. This allows the range of the main population to be kept narrow. It is significant for the distribution that the average particle diameter of the secondary population is so small compared to the main population that the species of the secondary population occupy the cavities of the main population in a tight packing. This allows a lowering of the tamped density which is associated with the reduction in the degree of order to be compensated or alleviated. In the case of bimodal distributions, this is because it allows higher occupation of space to be achieved than in a comparable monomodal distribution. In addition, more contact sites between individual particles are created, which has a positive effect on the durability of the storage material and also has the effect of a large BET surface area.

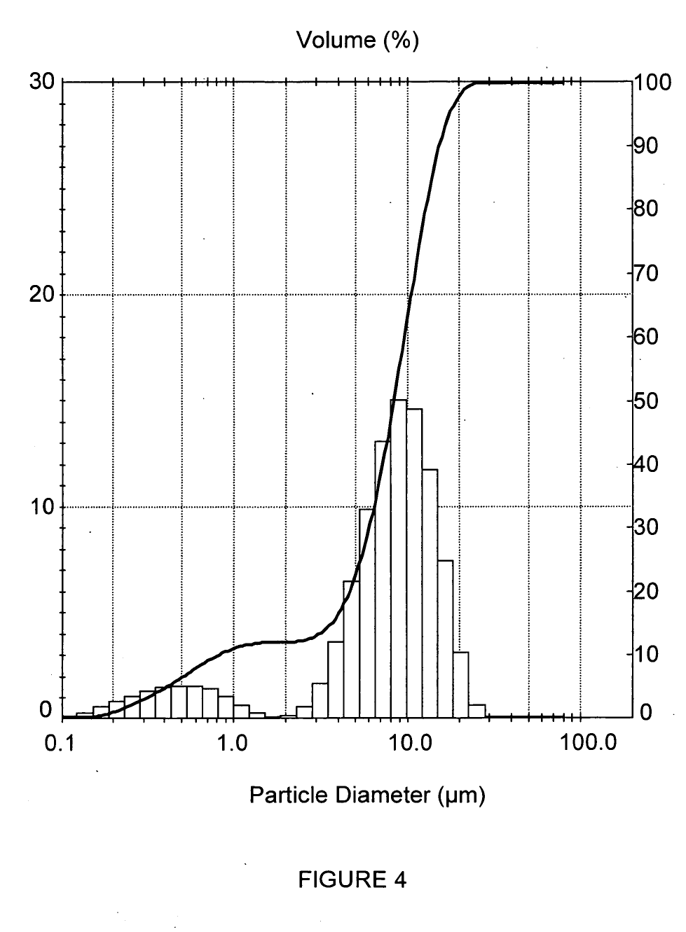

The median value of the mass-based particle size distribution is derived from the volume-based particle size of the mixed nickel hydroxide which has been determined by means of a laser particle analysis and is shown in FIGS. 4, 5 and 6 for the inventive mixed nickel hydroxide at various experiment times. A volume-based particle size distribution is converted to a mass-based particle size distribution by the relationship
mᵢ=^{ρi}_{ρ}Vᵢ
where mᵢ=mass fraction of the particle size class i, ρᵢ=density of the particles of the particle size class i, ρ=true density of the mixed nickel hydroxide, and Vᵢ=volume fraction of the particle size classes i. With reference to analyses on a scanning electron microscope and based on energy-dispersive x-ray microanalyses, it was possible to derive a material composition and density independent of the particle size of
ρᵢ=ρ=3.56 g/cm³,
so that the mass-based particle size distribution of the inventive mixed nickel hydroxide is identical to the volume-based particle size distribution.

According to an exemplary embodiment, the median of the main population of the particles is between 6 and 12 μm and the median of the secondary population is between 0.3 and 1.5 μm. In a further embodiment, particular preference is given to a mass fraction of the main population of from 70 to 95% by weight.

A mixed hydroxide refers generally to a hydroxide which contains various cations. A mixed nickel hydroxide refers hereinbelow to a mixed hydroxide which contains, as cations, mainly nickel(II) ions, but additionally small amounts of further cations to influence the physicochemical and in particular the electrical properties.

The mixed nickel hydroxide cathode material according to this invention preferably has such a composition that it consists, with regard to the cations, of nickel and additionally at least one constituent from the group of magnesium, calcium, zinc, cobalt, aluminum, manganese, iron, chromium, and rare earth metals.

In addition, the mixed hydroxide may contain mono- or divalent anions, in particular from the group of chloride, nitrate, sulfate. Like the other di- and trivalent cations present in a minor amount, these may be incorporated into the nickel hydroxide crystal structure.

The nickel content of the mixed nickel hydroxide cathode material is preferably from 40 to 60% by weight, further preferably from 55 to 59% by weight, based on the dry mass. The specific surface area of the inventive mixed oxide is from 10 to 100 m²/g, preferably between 15 to 40 m²/g, in each case measured as BET values.

The improved properties of the mixed nickel hydroxide material are achieved by it having a particular bimodal particle size distribution.

At a suitable sphere diameter ratio, powders having bimodal size distribution have a higher packing density in comparison to powder with corresponding monomodal particle distribution and the same true density and morphology. In addition, the internal surface area of the material and the number of contact sites per unit volume increase. In spite of substantially lower compactness of the precipitated materials, it is possible to achieve tamped densities between 1.8 g/cm³ and 2.0 g/cm³. The electrochemical storage capacity rises to above 260 mAh/g. The materials sediment rapidly, are readily filterable and extractively washable, and have a substantially increased BET surface area at from 20 m²/g to 40 m²/g. They consist of rounded agglomerates of amorphous spherical primary particles which themselves consist in turn of 100 to 200 nm-sized crystals arranged in a mosaic. Further positive electrochemical properties of the inventive material such as increased durability likewise result from the above-described bimodal distribution.

Essential for the inventive effect is a suitable sphere diameter ratio of the populations associated with a suitable mass ratio between these populations, as has not yet been established in the prior art. For example, the range between the percentiles D_{90%} and D_{10%} of the mass-based particle distribution of main and secondary population is such that it does not overlap. The percentiles specify the x value at which the total distribution over the variable x has attained the corresponding percentage of the overall distribution.

The mixed nickel hydroxide material can be produced by a precipitation process in a loop reactor with an integrated clarifying zone, as described in detail hereinbelow. The integrated clarifying zone allows the average residence time of the solid in the reactor to be selected substantially independently of the residence time of the reaction solution.

The fact that the preparation of the inventive cathode material with bimodal particle size distribution actually succeeds in a loop reactor with integrated clarifying zone is surprising in that materials from such precipitation processes are known to be commonly characterized by a very uniform monomodal, sometimes extremely narrow-band, particle size distribution (Scherzberg et al. (1998) Scherzberg, H.; Kahle, K.; Kaseberg, K.; Chemie Ingenieur Technik 70 12/1998 p. 1530-1535). The average size of the particles and the width of the mass distribution of the particle diameters depend upon a series of physical and chemical influences and are both substance- and process-specific. Nickel hydroxides prepared by the route described in Scherzberg et al. have a radiated structure of the particles and a narrow-band particle size distribution. Owing to the selected conditions, the precipitated materials grow rapidly in very compact form to give spherical particles. They tend to rapid sedimentation, have excellent filter properties and can very readily be extractively washed. The BET surface area of the materials is generally approx. 10 m²/g at tamped densities >2.1 g/cm³. However, the electrochemical storage capacity of these materials at values between 220 mAh/g and 240 mAh/g is distinctly below other known materials.

It has now been found in the precipitation of mixed nickel hydroxides that, surprisingly, with suitable adjustment of the parameters, it is possible to temporarily stabilize a state in which a second population occurs with distinctly smaller average particle diameters and in a ratio approximately constant over time to the coarse-particle main population, and makes up from about 5 to 30% of the total mass. It is precisely these ratios, as has been found, that are particularly important for the advantageous properties of the material.

In the inventive parameter adjustment of the above-described process, what are known as oscillation phenomena occur, in which the average particle size initially grows continuously and the number of crystallization seeds is increasingly reduced until a second population of particles having substantially smaller diameter has formed. This population subsequently grows continuously both with regard to the quantitative fraction and with regard to the particle diameter. The desired material is removed in an experimentally determined time window.

One possible production process for the inventive mixed nickel hydroxide cathode material which has not been preparable by the precipitation processes known to date consists in bringing about the oscillation phenomena in the reactor with regard to the particle size selectively by the parameter adjustment. It has been found that this results in synchronous mixing, during the precipitation step, of a precipitate consisting of ultrafine primary particles and a coarse-particle agglomerate resulting from another formation phase, and in a material with bimodal distribution.

A further way of generating a bimodal particle size distribution synchronously with a precipitation step in a continuous process consists in initiating a spontaneous increase in the number of primary particles by abrupt supply of metal salt at regular intervals in addition to the continuous stream. The increased number of crystal seeds results in a second product population with lower particle diameter.

The process according to an exemplary embodiment for producing the desired mixed nickel hydroxide cathode material is therefore generally characterized in that a reaction mixture composed of mixed nickel hydroxide, for example of an aqueous solution of alkali metal ions, nickel(II) ions, ammonia, OH ions and of at least one constituent of the group of the divalent or trivalent cations, in particular magnesium, calcium, zinc, cobalt, aluminum, manganese, iron, chromium, rare earths, and at least one constituent from the group of the monovalent or divalent anions, in particular chloride, nitrate, sulfate is present in a loop reactor with integrated clarifying zone, and that the mixed oxide is formed by adding a nickel(II) salt solution provided with further metal ions, in particular the aforementioned cations, an aqueous ammonia solution and an alkali metal hydroxide solution, and the particulate mixed nickel hydroxide cathode material formed is discharged as a solid together with fractions of the liquid component of the reaction mixture and sent to a solid/liquid separation. In this process, the nickel(II) salt solution and the alkali metal hydroxide solution may alternatively be added substantially simultaneously at substantially constant pH, or in addition to the continuous and substantially simultaneous addition of the nickel salt solution and the alkali metal hydroxide solution, volume fractions between 0.5 and 15% of the nickel salt solution to be metered in and the alkali metal hydroxide solution to be metered in may be added at regular intervals between 0.5 and 5 hours in portions to the reaction mixture, without this causing a lasting change in pH.

The added nickel(II) salt solution preferably contains between 80 and 125 g/l of nickel cations and one or more cations from the group of magnesium, calcium, zinc, cobalt, aluminum, manganese, chromium, iron, rare earths, in each case between 0.1 and 20 g/l.

The aqueous ammonia solution preferably contains between 1 and 25% by weight of ammonia.

The alkali metal hydroxide solution may consist of aqueous NaOH, KOH and/or LiOH solution and consists preferably exclusively of NaOH solution. The total alkali metal hydroxide content is between 10 and 30% by weight, preferably about 20% by weight, based on the total mass of the solution.

The concentrations in the reaction solution of the reaction mixture while carrying out the process are advantageously adjusted to from 50 g/l to 60 g/1 based on the total concentration of sodium, potassium and lithium, and to from 0.1 mg/l to 100 g/l of nickel(II) ions, to from 0.1 mg/l to 100 mg/l based on the total concentration of magnesium, calcium, zinc, cobalt, aluminum and manganese, the counterions present being OH⁻, chloride, nitrate and/or sulfate.

The solids content in the reaction mixture is advantageously adjusted to from 220 g/l to 400 g/l, preferably from 300 g/l to 380 g/l.

The product suspension removed from the mixed region of the loop reactor, is converted by means of known processes for solid/liquid separation, for example a vacuum belt filter, to a solids-free solution and to a solid having from 0.05 to 0.35 parts by mass of adhesive solution.

The solid particles discharged with the reaction solution overflowing in the reactor are collected in a downstream clarifying apparatus and recycled into the reactor.

The temperature of the reaction mixture is preferably kept constant over time at from 20° C. to 80° C., preferably from 30° C. to 60° C., and further preferably within an interval of ±1° C.

Depending on the temperature, the pH of the reaction solution is from 9.8 to 13.7, preferably from 11.6 to 12.9, and is kept constant over time within a tolerance of ±0.05.

The alkali metal hydroxide solution may be metered into the reactor in a molar ratio of from 0.9 to 1.3, preferably from 1.05 to 1.10, to the sum of the cations of the nickel(II) salt solution. It is advantageously introduced into the reactor directly below or directly at the liquid surface.

The nickel(II) salt solution is preferably introduced into the reactor below the liquid surface, further preferably in the hydrodynamic loop region.

The aqueous ammonia solution is also particularly advantageously introduced directly below or directly at the liquid surface, preferably in the immediate vicinity of the input of the nickel(II) salt solution.

It has been found to be very favorable for the product when between 7 kg/h and 30 kg/h, preferably between 18 kg/h and 25 kg/h, of mixed nickel hydroxide are produced per 1 m³ of reactor volume and the specific throughput is kept constant over time.

Particularly suitable reaction volumes are between 1 liter and 100 m³. In a particularly preferred embodiment, the loop reactor includes a pitched-blade stirrer, preferably a pitched 6-blade stirrer with vertical axial stirrer shaft, whose stirrer blades have a constant or progressive slope in the range from 15° to 85°, preferably from 30° to 60°, at a stirrer intensity of 150 W/m³ to 320 W/m³, preferably of from 290 W/m³ to 300 W/m³, and generates different flow rates within the guide tube, and shear forces within the reaction mixture.

A particularly advantageous procedure for generating the inventive mixed nickel hydroxide cathode material is based on a combination of mutually adjusted chemical, physical, and mechanical factors and includes:
a) the provision for a specific energy input of from 150 W/m³ to 320 W/m³, preferably of 290 W/m³;
b) the provision for a specific throughput of from 7 kg/h to 30 kg/h, preferably of from 15 kg/h to 25 kg/h, per m³ of reactor volume;
c) the establishment of a solids content of from 220 kg/m³ to 400 kg/m³, preferably from 300 kg/m³ to 380 kg/m³, based on the intensively mixed zone of the precipitation reactor;
d) the establishment of a constant excess of precipitant in the range of from 0 kg to 10 kg, preferably from 1.5 kg to 6.3 kg, per m³ of solution, based on the hydroxide ions;
e) the establishment of the temperature of the product suspension between 20° C. and 90° C.;
f) the supply of all streams required at different points in the intensively mixed reactor zone in the upper region of the loop flow; and
g) the use of a pitched-blade stirrer with constant or progressive slope of the stirrer blades in the range from 15° C. to 85° C., preferably from 30° C. to 60° C., which ensures that different flow rates occur within the guide tube and shear forces within the suspension, which influence the particle formation in the desired manner.

A reaction mixture for producing the inventive mixed nickel hydroxide material in a continuous process using the apparatus described consists of already prepared mixed nickel hydroxide and an aqueous solution of alkali metal ions, nickel(II) ions, ammonia, alkali metal hydroxide solution and of at least one constituent of the group of the divalent or trivalent cations, for example magnesium, calcium, zinc, cobalt, aluminum, manganese, iron, chromium, rare earths, in particular including lanthanoids, and at least one constituent from the group of the monovalent or divalent anions, for example chloride, nitrate, sulfate. A nickel(II) salt solution provided with further metal ions, an aqueous ammonia solution and an alkali metal hydroxide solution are added to this reaction mixture. The reaction solution contains from 50 to 60 g/l of alkali metal ions, from 0.1 to 100 mg/l of nickel(II) ions, from 0.1 to 100 mg/l of cations and from 0.1 to 200 g/l of anions. The nickel(II) salt solution contains from 80 to 125 g/l of nickel, from 0.1 to 20 g/l of at least one divalent or trivalent cation, for example magnesium, calcium, zinc, cobalt, aluminum, manganese, iron, chromium, rare earths, and monovalent or divalent anions, for example chloride, nitrate, sulfate. The alkali metal hydroxide solution contains from 10 to 30% of the mass of at least one of the constituents NaOH, KOH, LiOH, and optionally additionally NH₃. The aqueous ammonia solution contains from 1 to 25% by weight of the mass of ammonia.

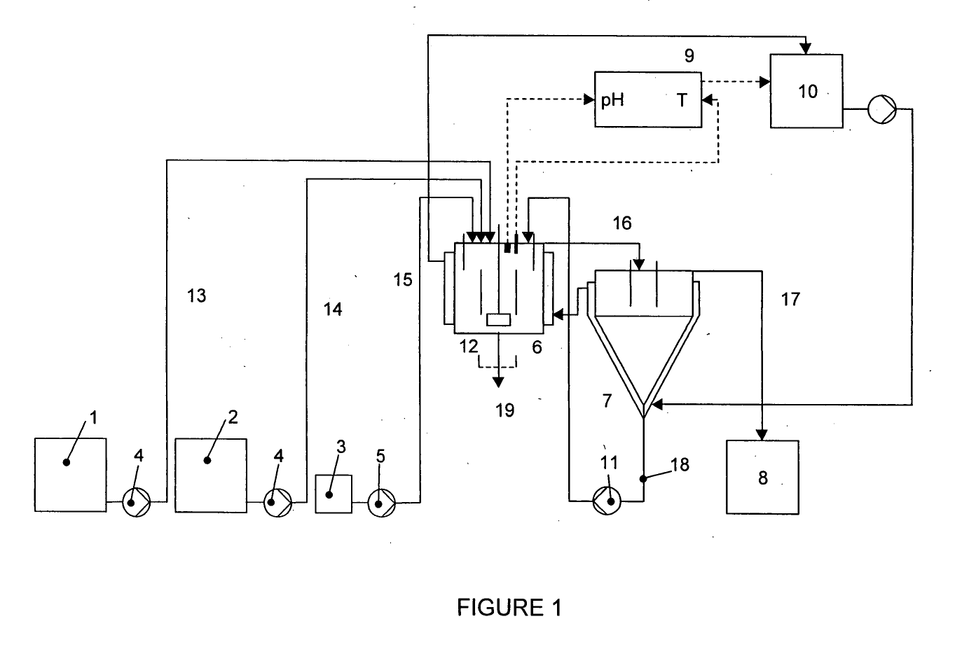

As shown in FIG. 1, according to an exemplary embodiment, doped nickel solution is disposed in a reservoir vessel 1, alkali metal hydroxide solution in a reservoir vessel 2, and an ammonia solution in a reservoir vessel 3. The solutions from the reservoir vessels are fed by means of pumps 4 and 5 through lines 13, 14 and 15 to the heated and heat-insulated loop reactor 6. Via the overflow 16 of the reactor 6, low-solids reaction solution is transferred into a heated and heat-insulated clarifying apparatus 7. The underflow of the clarifying apparatus 7 may be fed back into the reactor 6 with a pump 11 via a recycling line 18. Excess low-solids reaction solution may be collected in a reservoir vessel 8 via the overflow 17 of the clarifying apparatus 7. The heating circuit for the clarifying apparatus 7 and the loop reactor 6 has a heating bath 10 with pump. The precipitation products from the reactor 6 are freed of possible oversized particles via the reactor underflow 19 through a sieve 12 of mesh width 0.063 mm and pass as a product suspension 19 to the solid/liquid separation. The process is controlled by a regulator 9.

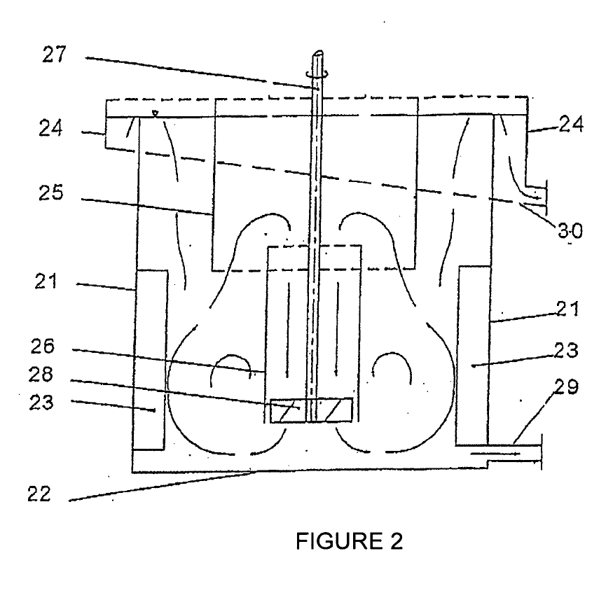

FIG. 2 shows the design of a loop reactor which is particularly suitable for the production of the inventive mixed nickel hydroxide material and has an integrated clarifying zone. A cylindrical vessel 21 has, for example, a flat or conical vessel bottom 22. To the interior of the vessel 21 are secured one or more wall baffles 23; for example, four wall baffles 23 may be arranged offset by an angle of in each case 90°. The loop reactor may be equipped with an overflow weir 24 in which excess low-solids reaction solution is collected and fed through a solution outlet 30, for example, to a clarifying apparatus 7. The solid particles discharged from the reactor with the reaction solution may be collected in the downstream clarifying apparatus 7 and recycled into the reactor. Roughly concentrically to the cylinder axis of the loop reactor, a circular separating sheet 25 and a circular guide tube 26 are mounted in the vessel 21. Within the guide tube 26 is disposed a stirrer 28 which is driven via a shaft 27, by which the suspension composed of reaction solution and precipitation products is kept in motion in the loop reactor. The stirrer may, for example, be a pitched-blade stirrer 28 with vertical axial stirrer shaft 27, whose pitched blades have a constant or progressive slope of from 15 to 85°, preferably from 30 to 60°. However, a conveying screw may also be installed in the guide tube 26. The thickened crystals or other precipitation products may be drawn off from the loop reactor by a crystals outlet 29 in the bottom region and subsequently filtered.

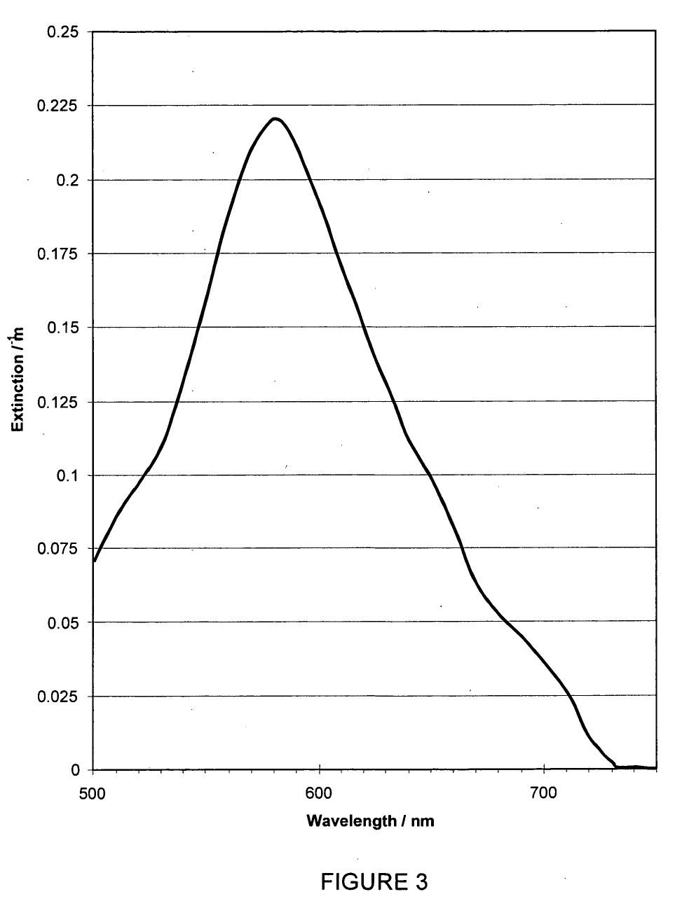

FIG. 3 shows a typical UV spectrum of a reaction solution, as used in the process according to the invention for preparing the mixed nickel hydroxide material with bimodal particle size distribution. This allows nickel(II) ions bound to ammonia in complexed form to be detected in the order of magnitude between 1 mg/l and 100 mg/l. The complex-bound residual nickel content of the reaction solution may thus be monitored by UV spectroscopy and if appropriate corrected by interventions into the pH regulation or the NH₃ addition.

FIGS. 4 to 6 show the particle size distribution which is established in Example 1 (described below) at different experimental times. The particle size distribution was determined by means of a laser particle analysis. A characteristic of this test method is that the results are volume-based and the theory of the evaluation is based on ideal spheres. The samples analyzed were produced from the washed and dried mixed nickel hydroxide cathode material by slurrying in deionized water. Owing to the findings of scanning electron microscope analyses and the energy-dispersive x-ray microanalyses, the determined volume-based particle size distribution and the mass-based particle size distribution can be assumed to be identical.

### EXAMPLES

The examples were carried out within a system according to FIG. 1 in a loop reactor according to FIG. 2. In the loop reactor used, it is possible, as already described, to select the average residence time of the solid in the reactor substantially independently of the residence time of the solution by integration of a clarifying zone. From the different vessels, a) the aqueous Ni salt solution provided with further additives, b) the alkali metal hydroxide solution and c) aqueous ammonia were metered into different regions in the loop reactor, below or at the liquid surface. The starting materials were metered at controlled temperature and controlled pH. A pitched six-blade stirrer having a vertical axial stirrer shaft and stirrer blades set between 15° and 85° was used to keep the product suspension in motion in the loop reactor. The product was discharged from the mixed region of the reactor, and the resultant suspension was subsequently filtered. The solid-state material discharged at the reactor overflow with the solution stream passed into a clarifying apparatus and was recycled from there into the reactor. The solution overflowing in the clarifying apparatus was collected together with the filtrate in a storage vessel.

The determinations of the particle size distribution were carried out with a Malvern mastersizer (laser particle analyzer).

The increase in the residence time of the solid compared to the solution allows the solids content to be increased to more than 350 g/l. The high particle density of the suspension and a high energy input through the stirrer lead to a product having high tamped density which is suitable as an active material for storage batteries. The mechanical stress on the solid in the mixed zone of the reactor causes the secondary population of the product having average particle diameters between 0.5 μm and 1 μm. The main population has a median of from 6 to 12 μm. In this way, a bimodally distributed mixed nickel hydroxide can be obtained without an additional mixing step.

### Example 1

Example 1 describes a continuous preparation process.

A nickel/zinc sulfate solution having 115 g/l of nickel and 8.7 g/l of zinc is introduced by means of a metering pump into the intensively mixed zone of a loop reactor having integrated clarifying zone and capacity of 400 l. As a complexing agent, 25% aqueous ammonia solution is fed into the reactor in a ratio of 0.7 mol of NH₃ to 1 mol of nickel in the immediate vicinity of the sulfate solution input. A 20% aqueous sodium hydroxide solution is fed in a ratio of 1.1 mol of NaOH to 1 mol of nickel directly into the region of the loop flow of the mixed zone in the reactor. At a temperature of the reaction solution of from 20° C. to 90° C. and a pH of 12.6, the inventive mixed nickel hydroxide is formed. The solids density in the reactor increases to 350 g/l over a period of 19 h. Afterward, the crystals which are withdrawn from the reactor in an amount of 9.5 kg per-hour can be discharged. The specific throughput is about 20 kg/(h·m³).

The following properties of the washed and dried mixed nickel hydroxide material were determined after different reaction times:

| | | Median D₅₀ of the | | | |
|---|---|---|---|---|---|
| Reaction | Median D₅₀ of the | secondary | Mass distribution | | Tamped |
| time | main population | population | Main population:secondary | BET | density |
| h | μm | μm | population | m²/g | g/cm³ |
| 24 | 9.6 | 0.53 | 88:12 | 43.6 | 1.7 |
| 46 | 7.8 | 0.55 | 87:13 | 34.2 | 1.8 |
| 62 | 8.6 | 0.63 | 89:11 | 32.2 | 1.9 |
| 78 | 8.9 | 0.60 | 88:12 | 26.0 | 1.9 |

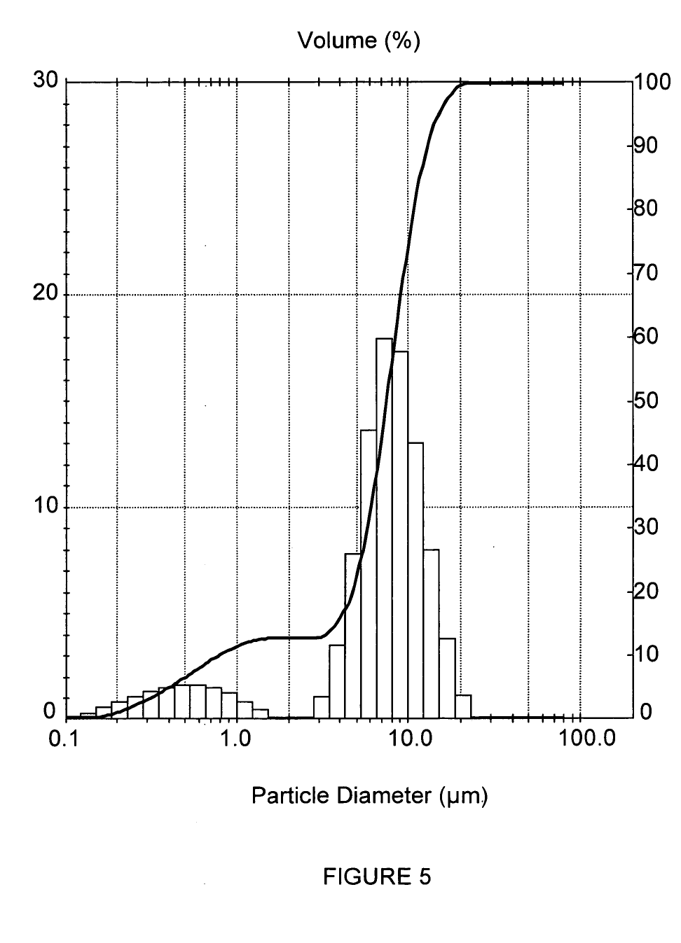

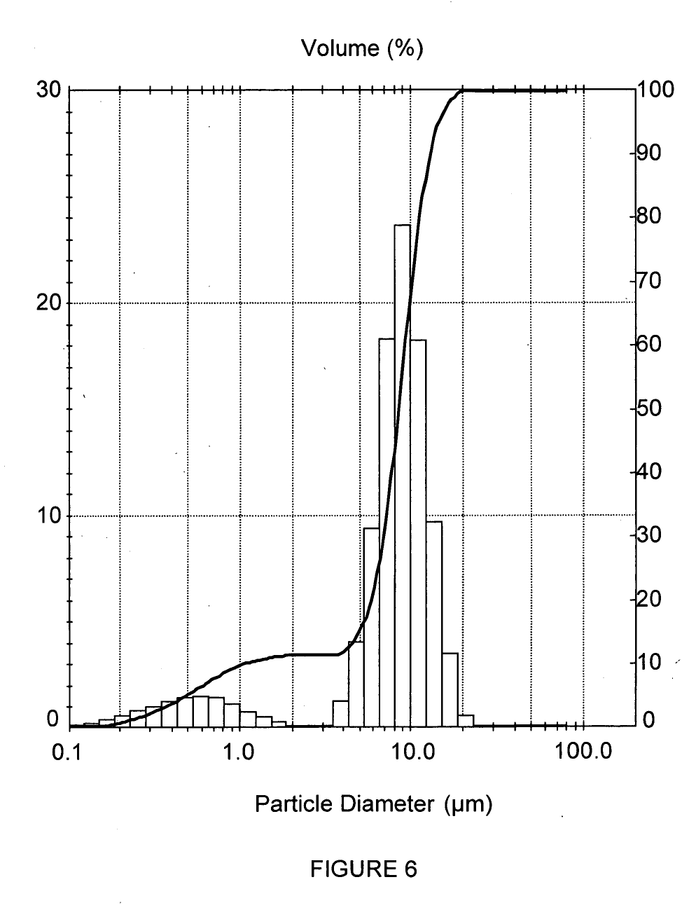

The distribution of the particle sizes and their fraction in the total volume after a reaction time of 24 hours can be taken from FIG. 4, after 46 hours from FIG. 5, and after 78 hours from FIG. 6.

### Example 2

Example 2 describes the process in which a bimodally distributed nickel hydroxide is generated by spontaneous addition of nickel sulfate solution and sodium hydroxide solution.

A nickel/zinc sulfate solution having 115 g/l of nickel and 8.7 g/l of zinc was introduced by means of a metering pump into the intensively mixed zone of the precipitation reactor in a loop reactor with integrated clarifying zone and capacity 22 liters. As a complexing agent, 25% aqueous ammonia was fed into the reactor in a ratio of 0.7 mol of NH₃ to 1 mol of nickel in the immediate vicinity of the sulfate solution input. A 20% aqueous sodium hydroxide solution was fed in a ratio of 1.07 mol of NaOH to 1 mol of nickel directly into the region of the loop flow of the mixed zone in the reactor. The temperature in the reaction medium was 60° C. and the specific throughput 20 kg/h m³. A mixed nickel hydroxide having an average particle size of the main population of 13-15 μm was obtained. The percentage mass fractions of the secondary population was 0-4%. After 52 experimental hours, in each case 4% of the nickel/zinc sulfate solution fed per hour and 16% of the NaOH solution fed per hour were simultaneously fed at intervals of 2 hours to the reaction medium in the reactor by introduction in portions. In the 76^{th} experimental hour, a mixed nickel hydroxide having a median of the main population of 12.0 μm and a median of the secondary population of 0.8 μm and having a mass distribution of main to secondary population of 95% to 5% was obtained.

The following properties of the washed and dried product were determined at different experimental times:

| Experi- | | | Median D₅₀ | Median D₅₀ | |
|---|---|---|---|---|---|
| mental | Tamped | | main | secondary | Distribution |
| hour | density | BET | population | population | Main:Secondary |
| h | g/cm³ | M²/g | μm | μm | population |
| 16^{th} | 2.0 | 12.6 | 13.1 | — | 100:0 |
| 48^{th} | 2.0 | 11.3 | 15.8 | 1.5 | 96:4 |
| 76^{th} | 1.9 | 16.6 | 12.0 | 0.8 | 95:5 |
| 90^{th} | 2.0 | 17.4 | 10.8 | 0.8 | 94:6 |

### Example 3

Example 3 describes the preparation process which was interrupted after intermediate preparation of the bimodal mixed nickel hydroxide, and the reactor was emptied and the process was subsequently started up again.

A nickel/zinc sulfate solution having 115 g/l of nickel and 8.7 g/l of zinc was introduced by means of a metering pump into the intensively mixed zone of the precipitation reactor in a loop reactor with integrated clarifying zone and capacity 22 liters. As a complexing agent, 25% aqueous ammonia was fed into the reactor in a ratio of 0.7 mol of NH₃ to 1 mol of nickel in the immediate vicinity of the sulfate solution input. A 20% aqueous sodium hydroxide solution was fed in a ratio of 1.3 mol of NaOH to 1 mol of nickel directly into the region of the loop flow of the mixed zone in the reactor. The temperature in the reaction medium was 40° C. and the specific throughput 20 kg/h m³. The discharge of the product suspension from the reactor from the 16^{th} experimental hour was 60 liters per 1 m³ of reactor volume per hour, so that the solids content in the volume of the mixed zone rose to 450 g per liter of suspension volume over a period of 55 experimental hours. With experimental conditions kept constant, the following periodic particle size distribution was established. At the start of the experiment (7^{th} experimental hour), a product having a monomodal particle size distribution and average particle size of 5.8 μm was obtained. At the time of maximum solids content at the 55^{th} experimental hour, a product was present with bimodal distribution, with a median of the main population of 7.8 mm, a median of the secondary population of 0.7 and a mass distribution of main population to secondary population of 96:4. A monomodally distributed product having a median of 4.5 μm was obtained after 78 experimental hours, while a bimodally distributed product having a median of the main population of 5.4 μm and a median of the secondary population of 0.7 μm and with a mass distribution of main to secondary population of 90 to 10 was in turn obtained after 93 experimental hours.

The following properties of the washed and dried product were determined at different experimental times:

| | | | Median | Median | |
|---|---|---|---|---|---|
| | | | D_{50%} | D_{50%} | |
| Experimental | Tamped | | main | secondary | Distribution |
| hour | density | BET | population | population | Main:secondary |
| h | g/cm³ | m²/g | μm | μm | population |
| 7^{th} | 1.4 | 33.7 | 5.8 | — | 100:0 |
| 55^{th} | 2.0 | 18.9 | 7.8 | 0.7 | 96:4 |
| 78^{th} | 1.5 | 16.6 | 4.5 | — | 100:0 |
| 93^{rd} | 1.8 | 29.1 | 5.4 | 0.7 | 90:10 |

It is also important to note that the various exemplary embodiments described herein are illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the preferred and other exemplary embodiments without departing from the scope of the present inventions as expressed in the appended claims.

1. A mixed nickel hydroxide cathode material for use in alkaline storage batteries and having a bimodal particle size distribution, the mixed nickel hydroxide cathode material comprising:
a main population of particles; and
a secondary population of particles;
wherein the main population has a median mass-based particle size distribution value, derived from laser particle analyses, of between 5 μm and 25 μm;
wherein the secondary population has a median mass-based particle size distribution value, derived from laser particle analyses, of between 0.3 μm and 3 μm; and
wherein the main population is present in the mixed nickel hydroxide cathode material in a proportion of between 70% and 96% by mass.

2. The mixed nickel hydroxide cathode material of claim 1 wherein the median mass-based particle size distribution value of the main population is between 6 and 12 μm and the median mass-based particle size distribution value of the secondary population is between 0.3 and 1.5 μm.

3. The mixed nickel hydroxide cathode material of claim 1 wherein the ranges between the percentiles D_{90%} and D_{10%} of the mass-based particle distribution of the main population and the secondary population do not overlap.

4. The mixed nickel hydroxide cathode material of claim 1 wherein the mixed nickel hydroxide cathode material comprises nickel(II) cations and at least one cation constituent selected from the group consisting of magnesium, calcium, zinc, cobalt, aluminum, manganese, iron, chromium, and rare earth metals.

5. The mixed nickel hydroxide cathode material of claim 1 wherein the mixed nickel hydroxide cathode material comprises at least one anion constituent selected from the group consisting of chloride, nitrate, and sulfate.

6. The mixed nickel hydroxide cathode material of claim 1 wherein the mixed nickel hydroxide cathode material comprises at least one divalent or trivalent cation and at least one monovalent or divalent anion.

7. The mixed nickel hydroxide cathode material of claim 1 wherein the mixed nickel hydroxide cathode material comprises nickel(II) cations and the fraction of nickel in the material is from 40% to 60% by weight based on the dry mass.

8. The mixed nickel hydroxide cathode material of claim 7 wherein the fraction of nickel in the material is from 55% to 59% by weight based on the dry mass.

9. The mixed nickel hydroxide cathode material of claim 1 wherein the mixed nickel hydroxide cathode material has a specific surface area that is between 10 and 100 m²/g (BET).

10. The mixed nickel hydroxide cathode material of claim 9 wherein the mixed nickel hydroxide cathode material has a specific surface area that is between 15 and 40 m²/g (BET).

11. A process for producing a mixed nickel hydroxide cathode material comprising:
providing a reaction mixture in a loop reactor having an integrated clarifying zone, the reaction mixture comprising mixed nickel hydroxide, an aqueous solution of alkali metal ions, nickel(II) ions, ammonia, OH⁻ ions, at least one cation selected from the group consisting of divalent and trivalent cations, and at least one anion selected from the group consisting of monovalent and divalent anions;
adding to the reaction mixture a nickel(II) salt solution provided with metal ions, an aqueous ammonia solution, and an alkali metal hydroxide solution to form a particulate mixed nickel hydroxide cathode material;
discharging the particulate mixed nickel hydroxide cathode material from the loop reactor as a solid with the reaction mixture; and
filtering the particulate mixed nickel hydroxide cathode material from the reaction mixture.

12. The process as claimed in claim 11 wherein the at least one cation comprises at least one cation selected from the group consisting of magnesium, calcium, zinc, cobalt, aluminum, manganese, iron, chromium, and rare earth metals.

13. The process of claim 11 wherein the at least one anion comprises at least one anion selected from the group consisting of chloride, nitrate, and sulfate.

14. The process of claim 11 wherein the metal ions provided with the nickel(II) salt solution comprise at least one cation selected from the group consisting of magnesium, calcium, zinc, cobalt, aluminum, manganese, iron, chromium, and rare earth metals.

15. The process of claim 11 wherein the nickel(II) salt solution and the alkali metal hydroxide solution are added substantially simultaneously at substantially constant pH.

16. The process of claim 15 wherein, in addition to the continuous and substantially simultaneous addition of the nickel(II) salt solution and the alkali metal hydroxide solution, volume fractions of between 0.5 and 15% of the nickel(II) salt solution to be metered in and the alkali metal hydroxide solution to be metered in are added at regular intervals between 0.5 and 5 hours in portions to the reaction mixture, without this causing a lasting change in pH.

17. The process of claim 11 wherein the added nickel(II) salt solution contains between 80 and 125 g/l of nickel and between 0.1 and 20 g/l of at least one cation selected from the group consisting of magnesium, calcium, zinc, cobalt, aluminum, manganese, iron, chromium, and rare earth metals.

18. The process of claim 11 wherein the aqueous ammonia solution comprises between 1 and 25% by weight of ammonia.

19. The process of claim 11 wherein the alkali metal hydroxide solution comprises at least one material selected from the group consisting of aqueous NaOH, KOH and LiOH solutions, and the total alkali metal hydroxide content is between 10 and 30% by weight based on the total mass of the solution.

20. The process of claim 19 wherein the alkali metal hydroxide solution comprises a NaOH solution.

21. The process of claim 19 further comprising adjusting the concentrations of the constituents of the reaction mixture while carrying out the process to from 50 g/l to 60 g/l based on the total concentration of sodium, potassium, and lithium, and to from 0.1 mg/l to 100 g/l of nickel(II) ions, to from 0.1 mg/l to 100 mg/l based on the total concentration of magnesium, calcium, zinc, cobalt, aluminum, manganese, iron, chromium, and rare earths, the counterions present being at least one anion selected from the group consisting of OH⁻, chloride, nitrate and sulfate.

22. The process of claim 11 further comprising adjusting the solids content in the reaction mixture to from 220 g/l to 400 g/l.

23. The process of claim 22 further comprising adjusting the solids content in the reaction mixture to from 300 g/l to 380 g/l.

24. The process of claim 11 wherein the discharged solid particles are collected in a downstream clarifying apparatus and recycled into the loop reactor.

25. The process of claim 11 wherein the temperature of the reaction mixture is between 20° C. and 80° C. and is kept constant with time within an interval of ±1° C.

26. The process of claim 11 wherein the temperature of the reaction mixture is between 30° C. and 60° C. and is kept constant with time within an interval of ±1° C.

27. The process of claim 11 wherein the pH of the reaction solution, depending on the temperature, is between 9.8 and 13.7 and is kept constant with time within a tolerance of ±0.05.

28. The process of claim 11 wherein the pH of the reaction solution, depending on the temperature, is between 11.6 and 12.9 and is kept constant with time within a tolerance of ±0.05.

29. The process of claim 11 wherein the alkali metal hydroxide solution is metered into the loop reactor in a molar ratio of between 0.9 and 1.3 to the sum of the cations of the nickel(II) salt solution.

30. The process of claim 11 wherein the alkali metal hydroxide solution is metered into the loop reactor in a molar ratio of between 1.05 and 1.10 to the sum of the cations of the nickel(II) salt solution.

31. The process of claim 11 wherein the alkali metal hydroxide solution is introduced into the loop reactor directly below or directly at a liquid surface of the reaction mixture.

32. The process of claim 11 wherein the nickel(II) salt solution is introduced into the loop reactor below a liquid surface of the reaction mixture.

33. The process of claim 11 wherein the aqueous ammonia solution is introduced into the loop reactor directly below or directly at a liquid surface of the reaction mixture in the immediate vicinity of the input of the nickel(II) salt solution.

34. The process of claim 11 wherein the reaction proceeds with the use of a pitched-blade stirrer whose stirrer blades have a constant or progressive slope in the range from 15° to 85° at a stirrer intensity of 150 W/m³ to 320 W/m³.
